(19) United States
(12) Patent Application Publication
(10) Pub. No.: US 2013/0313965 A1
(43) Pub. Date: Nov. 28, 2013

(54) Light Emitting Diode Unit

(71) Applicant: WALSIN LIHWA CORPORATION, (US)

(72) Inventor: Chung-I Chiang, Taoyuan (TW)

(73) Assignee: WALSIN LIHWA CORPORATION, Taoyuan (TW)

(21) Appl. No.: 13/875,724

(22) Filed: May 2, 2013

Related U.S. Application Data
(63) Continuation-in-part of application No. 12/707,993, filed on Feb. 18, 2010, now abandoned.

(51) Int. Cl. F21V 13/04; F21V 13/14

(52) U.S. Cl. CPC F21V 13/04; F21V 13/14
USPC 313/498; 313/111

(57) ABSTRACT

A light emitting diode unit comprising a light emitting diode chip, a reflecting unit, and a light condenser is provided in this invention. The light emitting diode chip is disposed on a substrate for providing a plurality of first light beams. The reflecting unit is installed on the substrate, surrounding the light emitting diode chip for reflecting the first light beams emitted from the light emitting diode chip, and sufficiently directing the first light beams upward. The light condenser is provided above the light emitting diode chip, having a light-incident pattern and a light-emitting flat plane, wherein the light-incident pattern faces to the light emitting diode chip for sufficiently receiving and guiding the first light beams upward via the light-emitting flat plane.

This is a continuation-in-part of U.S. application Ser. No. 12/707,993 filed Feb. 18, 2010, which is incorporated by reference in its entirety.

### CROSS-REFERENCES TO RELATED APPLICATIONS

Not applicable.

### BACKGROUND OF THE INVENTION

1. Field of the Invention

The present invention relates to a light emitting diode unit. More specifically, the present invention relates to a light emitting diode unit having a light condenser for guiding light beams.

2. Descriptions of the Related Art

When a light emitting diode is used, light extraction efficiency of the light emitting diode is dominated by its internal quantum efficiency and light extraction efficiency. Internal quantum efficiency relates to the efficiency of light generated from an active layer. Light extraction efficiency is the ability that the light from the active layer emits to medium surrounded. With development of epitaxy technology, internal quantum efficiency can be up to 80%. However, light extraction efficiency is still low. For example, refraction index of GaN-based materials is about 2.5. The air around them has refraction index of 1. Due to total reflection, the light extraction efficiency in the interface is only 10-12%.

In order to have better light extraction efficiency, many solutions have been provided. Therefore, high brightness light emitting diodes are available nowadays. When we look at applications of these light emitting diodes, there are still some shortcomings that need to be improved. For example, when a light emitting diode is used as a light source, a special lampshade is required. This is because light emitting diode is a scattering light source. Like conventional lamps, it needs a lampshade to collect all light beams including the light beams emitting laterally. The lampshade can not be too small for practice use and heat sink. However, if the light emitting diode is used as a backlighting source of a liquid crystal display or an indicator of traffic signals, it is better for the lighting set (the light emitting diode and lampshade) to be as small as possible.

In order to solve the problems, some prior arts have shown different solutions. Please refer to FIG. 1. U.S. Pat. No. 6,987,613 provides a light emitting device including a Fresnel lens or a holographic diffuser formed on a surface of a semiconductor light emitter for improving light extraction. '613 uses the Fresnel lens or holographic diffuser to guide some scattering light out of the light emitting diode below. It has the function of collimation of light beams and small size. However, there are still some light beams emitted laterally which can not be efficiently used.

Please refer to FIG. 2. U.S. Pat. No. 7,145,181 provides an improvement over '613 patent. It shows a light-emitting diode having a substrate, on which a sequence of semiconductor layers with an active zone are been applied. Above the sequence of semiconductor layers there is a stepped window layer which is structured in the manner of a Fresnel lens and has with regard to the coupling out of radiation the function of a hemispherical lens. Obviously, the invention may be more easily to be achieved. It still remains the same defect to utilize lateral light beams.

Please refer to FIG. 3. US Publication Number 20070034890 provides a light emitting device which includes a number of light emitting diode dies mounted on a shared submount and covered with a single lens element that includes a corresponding number of lens elements. The LEDs are separated from each other by a distance that is sufficient for lens element to include separate lens elements for each LED. The separation of the LEDs and lens elements may be configured to produce a desired amount of light on a target at a predefined distance. The lens elements are approximately flat type lens elements, such as Fresnel, TIR, diffractive lens, photonic crystal type lenses, prism, or reflective lens. The structure has better lighting efficiency than the mentioned prior arts. However, utilization of lateral light beams could be further improved.

Last, please refer to FIG. 4A and FIG. 4B, U.S. Pat. No. 8,039,859 provides a semiconductor light emitting device forming a concave or convex surface under the lens for improving uniformity of correlated color temperature (CCT) of the light emitting device. However, it is difficult to form a concave or convex surface between a light emitting diode chip and a lens in a kind of miniature light emitting devices since a distance between a light emitting diode chip and a lens is very short.

In view of this, an urgent need exists in the art to provide a light emitting diode unit that can improve at least one of the aforesaid shortcomings.

### SUMMARY OF THE INVENTION

An objective of the present invention is to provide a light emitting diode unit for providing collimated light beams, having small size and well utilizing lateral light beams so as to homogenize the correlated color temperature (CCT) of the light emitting diode chip.

To achieve the aforesaid objective, the light emitting diode unit of the present invention comprises a light emitting diode chip, a reflecting unit, and a light condenser. The light emitting diode chip is disposed on a substrate for providing a plurality of first light beams. The reflecting unit is installed on the substrate, surrounding the light emitting diode chip for reflecting the first light beams emitted from the light emitting diode chip, and sufficiently directing the first light beams upward. The light condenser is provided above the light emitting diode chip, having a light-incident pattern and a light-emitting flat plane, wherein the light-incident pattern faces to the light emitting diode chip for sufficiently receiving and guiding the first light beams upward via the light-emitting flat plane.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic section view of a prior art of a light emitting diode unit;

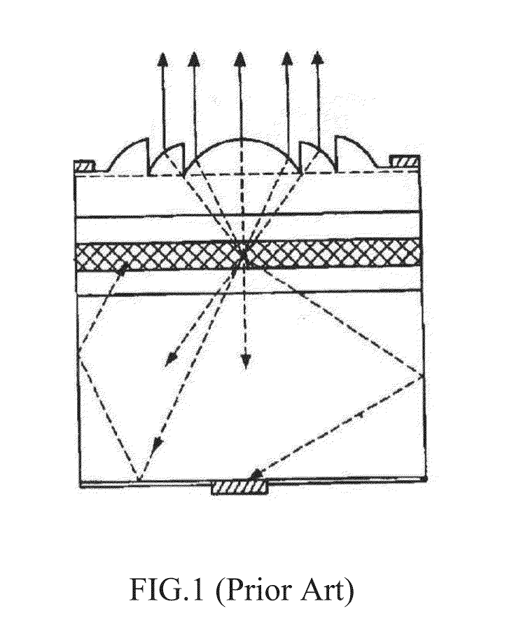

FIG. 2 is a schematic section view of another prior art of a light emitting diode unit;

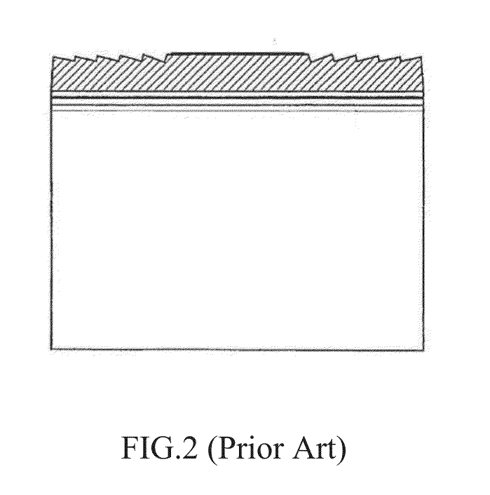

FIG. 3 is a schematic section view of another prior art of a light emitting diode unit;

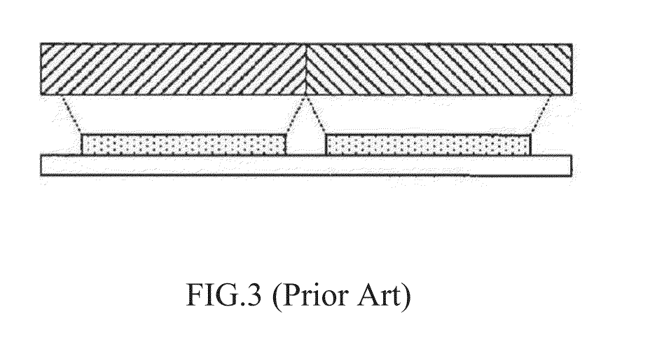

FIG. 4A and FIG. 4B are schematic section views of another prior art of a light emitting diode unit;

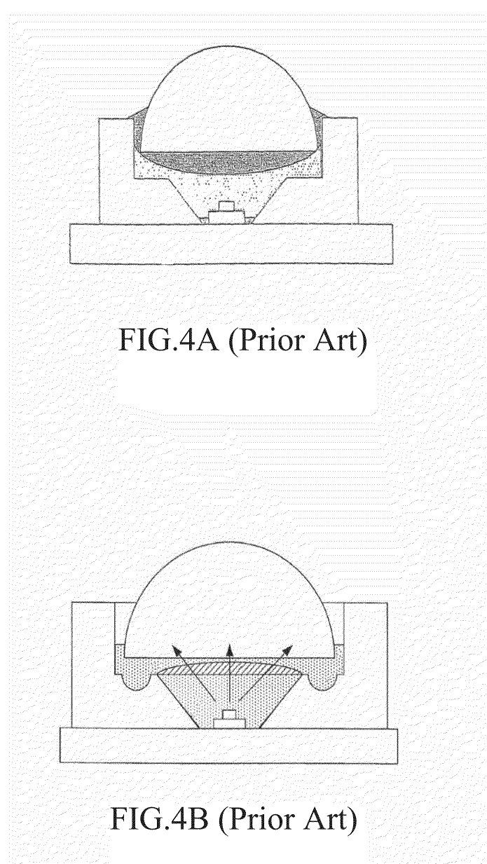

FIG. 5A is a schematic section view of a light emitting diode unit according to a first embodiment of the present invention;

FIG. 5B is a partially enlarged view of the light emitting diode unit showing a relative relation between a light emitting diode chip and a light condenser according to the first embodiment of the present invention;

FIG. 5C is a schematic section view of a light emitting diode unit according to another embodiment of the present invention;

FIG. 6 is a schematic section view of a light emitting diode unit according to a second embodiment of the present invention;

FIG. 7 is a schematic section view of a light emitting diode unit according to a third embodiment of the present invention;

FIG. 8A is a schematic section view of a light emitting diode unit according to another embodiment of the present invention;

FIG. 8B is a schematic section view of a light emitting diode unit according to another embodiment of the present invention; and

FIG. 9A and FIG. 9B illustrates that as the light emitted from the LED chip passes through the light condenser of the present invention, the light shape has been changed from FIG. 9A to FIG. 9B.

### DESCRIPTION OF THE PREFERRED EMBODIMENT

In the following descriptions, the present invention will be explained with reference to multiple embodiments thereof. However, the description of these embodiments is only to illustrate the technical contents and objectives and efficacies thereof of the present invention rather than to limit the present invention. It shall be appreciated that in the following embodiments and attached drawings, elements not directly related to the present invention are omitted from depiction; and the dimensional and positional relationships among individual elements in the attached drawings are illustrated only for the ease of understanding but not to limit the actual scale and size.

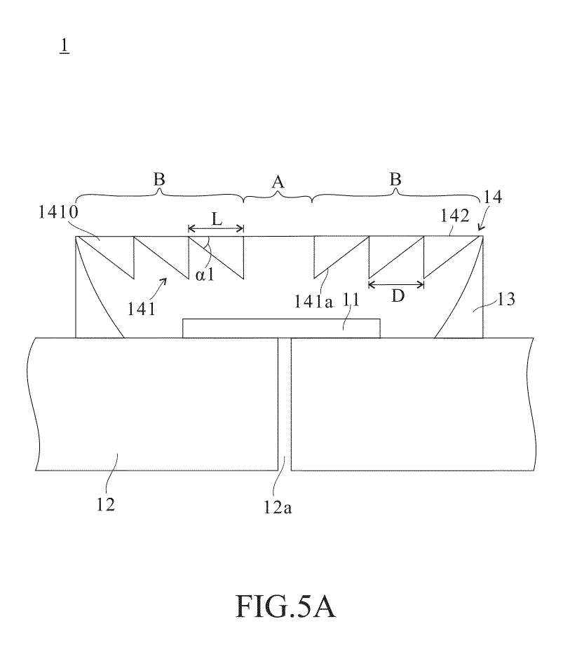

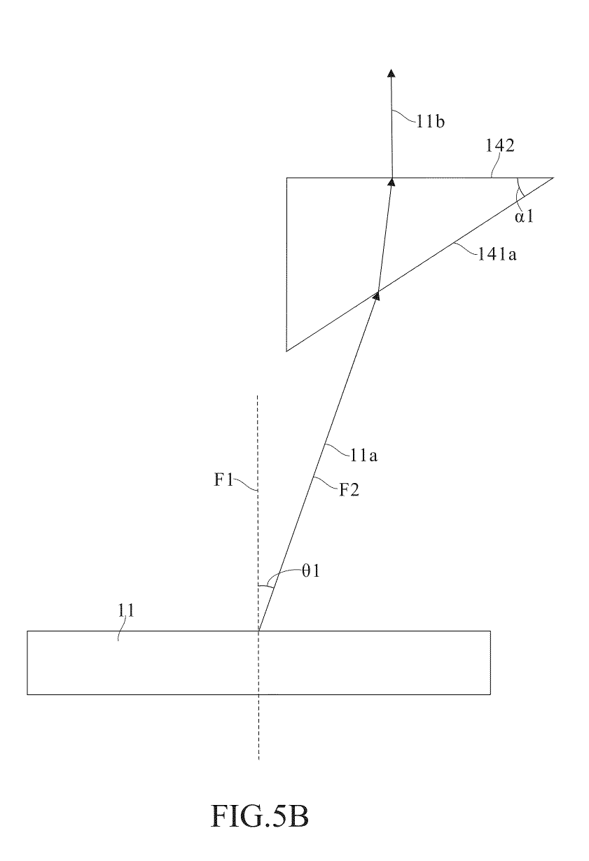

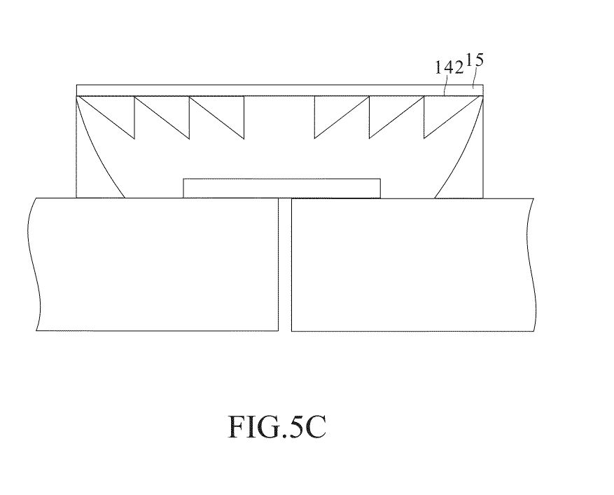

The first embodiment of the present invention is a light emitting diode unit 1. FIG. 5A illustrates a schematic section view of the light emitting diode unit 1. The light emitting diode unit 1 comprises a light emitting diode chip 11, a reflecting unit 13, and a light condenser 14.

With reference to FIG. 5A and FIG. 5B which is a partially enlarged view of the light emitting diode unit 1 showing a relative relationship between the light emitting diode chip 11 and a light condenser 14. The light emitting diode chip 11 is disposed on a substrate 12 for providing a plurality of first light beams 11a. The reflecting unit 13 is installed on the substrate 12, surrounding the light emitting diode chip 11 for reflecting the first light beams 11a emitted from the light emitting diode chip 11, and sufficiently directing the first light beams 11a upward. The light condenser 14 is provided above the light emitting diode chip 11, having a light-incident pattern 141 and a light-emitting flat plane 142, wherein the light-incident pattern 141 faces to the light emitting diode chip 11 for sufficiently receiving and guiding the first light beams 11a upward via the light-emitting flat plane 142.

The light-incident pattern 141 distributed on the light condenser 14 has a plurality of inclined planes 141a and a plurality of first included angles α1 defined between each of the inclined planes 141a and the light-emitting flat plane 142, and each of the first included angles α1 is not greater than 60 degrees. Preferably, The light-incident patterns 141 distributed on the light condenser 14 have different pattern. More specifically, the first included angles α1 are equal to 0 degree when the first light beams 11a emitted from the light emitting diode chip 11 with a emitting angle θ1, between perpendicular and emitting directions, smaller than 20 degrees, and the first included angles α1 are equal to 40 degrees when the emitting angle θ1 is not smaller than 20 degrees. That is to say, with reference to FIG. 5B, a virtual perpendicular line F1 is perpendicular to the light-emitting flat plane 142 and the light emitting diode chip 11. Each of the emitting directions F2 of the first light beams 11a and the first virtual perpendicular line F1 define the emitting angle θ1 therebetween. In more detail, with reference to FIG. 5A, each of the first included angles α1 located in Area A is equal to 0 degree when the emitting angle θ1 is smaller than 20 degrees, and each of the first included angles α1 located in Area B outside Area A is equal to 40 degrees when the emitting angle θ1 is not smaller than 20 degrees.

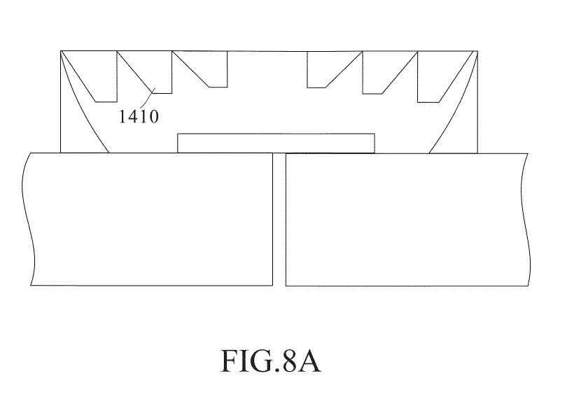

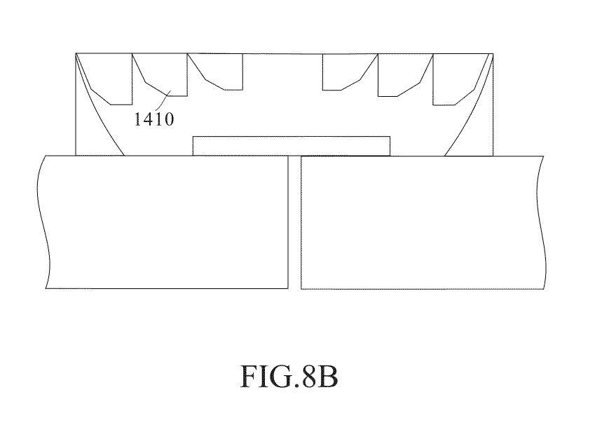

Moreover, the light-incident pattern 141 has a plurality of concentric rings 1410. Each of the concentric rings 1410 comprises the inclined plane 141a. A distance D between each of the concentric rings 1410 is not longer than 500 um. Each of the concentric rings 1410 has a length L between 10 to 500 um. In this embodiment, each of the concentric rings 1410 has a cross section of a triangle. However, in another embodiment of the present invention, a cross section of each of the concentric rings can be selected from a group consisting of triangle, trapezoid, polygon and their combination, as shown in FIG. 8A and FIG. 8B.

In one embodiment, the light condenser 14 further comprises phosphor materials for converting the first light beams 11a into second light beams 11b wherein the first light beams 11a can be the blue light beams and the second light beams 11b can be the white light beams. However, in another embodiment of the present invention, the light emitting diode unit further comprises a phosphor layer 15 formed on the light-emitting flat plane 142 as shown in FIG. 5C for converting the first light beams 11a into second light beams 11b.

It should be noticed that a refractive index of the light condenser 14 in this embodiment is between 1.4 and 1.7 and the light condenser 14 is a Fresnel lens made of epoxy resin, silicone, polyetherimide, fluorocarbon polymer, polymethyl methacrylate (PMMA), polycarbonate (PC), cyclo olefin copolymer (COC), glass or a mixture thereof. The reflective unit 13 is made of a metal.

As to the structure of the substrate 12, the substrate 12 has through silicon vias 12a (TSVs) for electric connection. That means wires (not shown) can pass through the silicon vias 12a from the top surface of the silicon substrate 12 to the bottom of the silicon substrate 12 to connect the light emitting diode unit 1 with other circuits (not shown). In the present invention, the substrate 12 is a silicon substrate, a ceramic substrate or a printed circuit board.

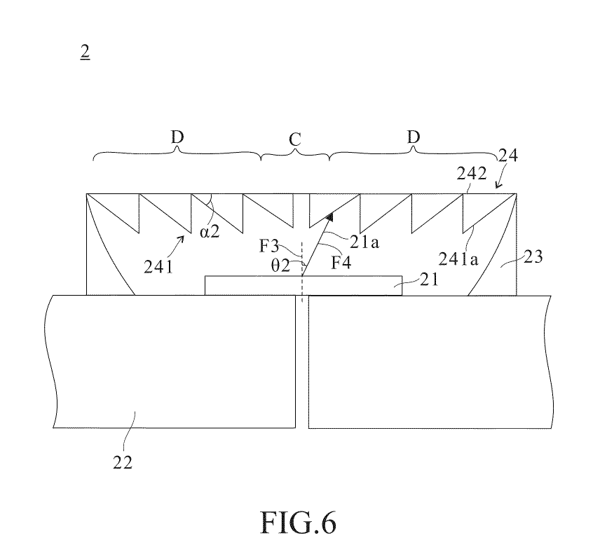

The second embodiment of the present invention is also a light emitting diode unit 2. With reference to FIG. 6, FIG. 6 is a schematic section view of the light emitting diode unit 2. In this embodiment, the light emitting diode unit 2 also has a light emitting diode chip 21, a reflecting unit 23, and a light condenser 24. The light emitting diode chip 21 is disposed on a substrate 22 for providing a plurality of first light beams 21a. The reflecting unit 23 is installed on the substrate 22, surrounding the light emitting diode chip 21 for reflecting the first light beams emitted from the light emitting diode chip 21, and sufficiently directing the first light beams upward. The light condenser 24 is provided above the light emitting diode chip 21, having a light-incident pattern 241 and a light-emitting flat plane 242, wherein the light-incident pattern 241 faces to the light emitting diode chip 21 for sufficiently receiving and guiding the first light beams upward via the light-emitting flat plane 242. The light-incident pattern 241 has a plurality of inclined planes 241a and a plurality of first included angles α2 defined between each of the inclined planes 241a and the light-emitting flat plane 242, and each of the first included angles α2 is not greater than 60 degrees. It is noted the technical features of this embodiment are similar with those of the first embodiment of the present invention, and thus, the same technical features will not be further described herein.

In addition, it shall be particularly appreciated that the second embodiment differs from the first embodiment mainly in that in the second embodiment, the first included angles α2 increase abaxially when the first light beams emit from the light emitting diode chip with a emitting angle θ2, between perpendicular and emitting directions, smaller than 30 degrees, and the first included angles α2 are equal to 40 degrees when the emitting angle θ2 is not smaller than 30 degrees. That is to say, with reference to FIG. 6, a virtual perpendicular line F3 is perpendicular to the light-emitting flat plane 242 and the light emitting diode chip 21. Each of the emitting directions F4 of the first light beams and the first virtual perpendicular line F3 define the emitting angle θ2 therebetween. In more detail, with reference to FIG. 6, the first included angles α2 located in Area C increase abaxially when the emitting angle θ2 is smaller than 30 degrees, and each of the first included angles α2 located in Area D is equal to 40 degrees when the emitting angle θ2 is not smaller than 30 degrees.

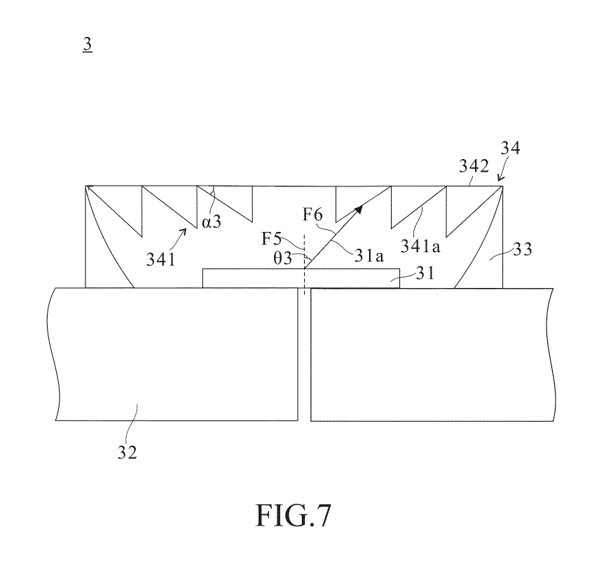

The third embodiment of the present invention is also a light emitting diode unit 3. FIG. 7 illustrates a schematic section view of the light emitting diode unit 3. The light emitting diode unit 3 of the third embodiment also has a light emitting diode chip 31, a reflecting unit 33, and a light condenser 34. The light emitting diode chip 31 is disposed on a substrate 32 for providing a plurality of first light beams 31a. The reflecting unit 33 is installed on the substrate 32, surrounding the light emitting diode chip 31 for reflecting the first light beams emitted from the light emitting diode chip 31, and sufficiently directing the first light beams upward. The light condenser 34 is provided above the light emitting diode chip 31, having a light-incident pattern 341 and a light-emitting flat plane 342, wherein the light-incident pattern 341 faces to the light emitting diode chip 31 for sufficiently receiving and guiding the first light beams upward via a light-emitting flat plane 342. The light-incident pattern 341 has a plurality of inclined planes 341a and a plurality of first included angles α3 defined between each of the inclined planes 341a and the light-emitting flat plane 342, and each of the first included angles α3 is not greater than 60 degrees. It is noted the technical features of this embodiment are similar with those of the first embodiment of the present invention, and thus, the same technical features will not be further described herein.

In addition, it shall be particularly appreciated that the third embodiment differs from the first embodiment and the second embodiment mainly in that in the third embodiment, the first included angles increase abaxially. In more detail, the first included angles α3 are smaller than 50 degrees when the first light beams emit from the light emitting diode chip with a emitting angle θ3, between perpendicular and emitting directions, smaller than 70 degrees. That is to say, with reference to FIG. 7, a virtual perpendicular line F5 is perpendicular to the light-emitting flat plane 342 and the light emitting diode chip 31. Each of the emitting directions F6 of the first light beams and the first virtual perpendicular line F4 define the emitting angle θ3 therebetween.

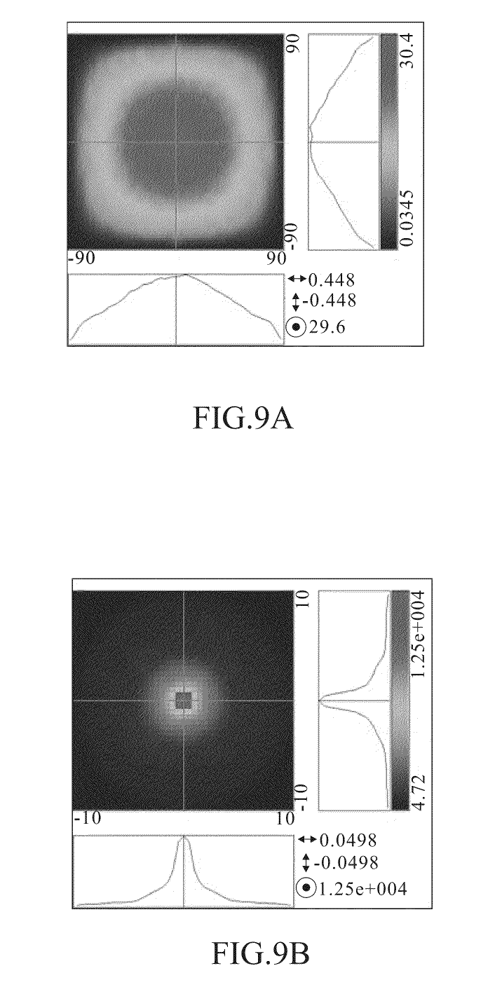

As shown in FIG. 9A and FIG. 9B, as the light emitted from the LED chip passes through the light condenser of the present invention, the light shape has been changed from FIG. 5A to FIG. 5B. That is, the light originally scattered has been sufficiently condensed or gathered centrally and the light extraction efficiency of the light emitting diode unit of the present invention would be improved. In addition, according to descriptions of the above embodiments, the light emitting diode unit of the present invention is adapted to control each of the first included angles of the light condenser to homogenize the correlated color temperature (CCT) of the light emitting diode chip and to utilize lateral light beams emitting from the light emitting diode chip. Moreover, since the light-incident pattern faces to the light emitting diode chip and locates between the reflecting units, the light emitting diode unit could have a desired small size.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light emitting diode unit comprising:
a light emitting diode chip disposed on a substrate for providing a plurality of first light beams;
a reflecting unit installed on the substrate, surrounding the light emitting diode chip for reflecting the first light beams emitted from the light emitting diode chip, and sufficiently directing the first light beams upward; and
a light condenser provided above the light emitting diode chip, having a light-incident pattern and a light-emitting flat plane,
wherein the light-incident pattern faces to the light emitting diode chip for sufficiently receiving and guiding the first light beams upward via the light-emitting flat plane.

2. The light emitting diode unit of claim 1, wherein the light-incident pattern has a plurality of concentric rings, and each of the concentric rings has a cross section selected from a group consisting of triangle, trapezoid, polygon and their combination.

3. The light emitting diode unit of claim 1, wherein the light-incident pattern has a plurality of inclined planes and a plurality of first included angles defined between each of the inclined planes and the light-emitting flat plane, and each of the first included angles is not greater than 60 degrees.

4. The light emitting diode unit of claim 3, wherein the first included angles are equal to 0 degree when the first light beams emit from the light emitting diode chip with a emitting angle, between perpendicular and emitting directions, smaller than 20 degrees, and the first included angles are equal to 40 degrees when the emitting angle is not smaller than 20 degrees.

5. The light emitting diode unit of claim 3, wherein the first included angles increase abaxially when the first light beams emit from the light emitting diode chip with a emitting angle, between perpendicular and emitting directions, smaller than 30 degrees, and the first included angles are equal to 40 degrees when the emitting angle is not smaller than 30 degrees.

6. The light emitting diode unit of claim 3, wherein the first included angles increase abaxially.

7. The light emitting diode unit of claim 6, wherein the first included angles are smaller than 50 degrees when the first light beams emit from the light emitting diode chip with a emitting angle, between perpendicular and emitting directions, smaller than 70 degrees.

8. The light emitting diode unit of claim 2, wherein a distance between each of the concentric rings is not longer than 500 um.

9. The light emitting diode unit of claim 2, wherein each of the concentric rings has a length between 10 to 500 um.

10. The light emitting diode unit of claim 1, wherein, wherein the substrate has through silicon vias (TSVs) for electric connection.

11. The light emitting diode unit of claim 1, wherein a refractive index of the light condenser is between 1.4 and 1.7.

12. The light emitting diode unit of claim 1, wherein the substrate is a silicon substrate, a ceramic substrate or a printed circuit board.

13. The light emitting diode unit of claim 1, wherein the light condenser is a Fresnel lens made of epoxy resin, silicone, polyetherimide, fluorocarbon polymer, polymethyl methacrylate (PMMA), polycarbonate (PC), cyclo olefin copolymer (COC), glass or a mixture thereof.

14. The light emitting diode unit of claim 13, wherein the light condenser further comprises phosphor materials for converting the first light beams into second light beams.

15. The light emitting diode unit of claim 1, further comprising a phosphor layer formed on the light-emitting flat plane for converting the first light beams into second light beams.
